(19) United States
(12) Patent Application Publication
(10) Pub. No.: US 2025/0224584 A1
(43) Pub. Date: Jul. 10, 2025

(54) A MULTIDUCT OR FLATLINER ASSEMBLY WITH A TENSILE STRENGTH UNIT FOR GUIDING AND PROTECTING OPTICAL FIBRE CABLES

(71) Applicant: GM PLAST A/S, Hedensted (DK)

(72) Inventor: Uffe Gramm MOGENSEN, Vejle Øst (DK)

(21) Appl. No.: 18/845,067

(22) PCT Filed: Mar. 7, 2023
(86) PCT No.: PCT/DK2023/050037

§ 371 Date: Sep. 9, 2024

(30) Foreign Application Priority Data
Mar. 8, 2022 (DK) PA202270089

(51) Int. Cl. G02B 6/44; F16L 11/08; F16L 11/22

(52) U.S. Cl. CPC G02B 6/4459; F16L 11/08; F16L 11/22

(57) ABSTRACT

A multiduct or flatliner assembly for guiding and protecting optical fiber cables or optical waveguides is provided, the multiduct or flatliner assembly including —an outer sheath supporting a plurality of first longitudinal guides being in parallel relationship with the outer sheath and —at least one tensile strength unit extending inside the outer sheath, and/or —at least one longitudinal fiber rod extending inside the outer sheath, and/or —at least one metal rod extending inside the outer sheath, and/or —aramid fibers extending inside the outer sheath, and/or —fiberglass extending inside the outer sheath, and —the plurality of first longitudinal guides is adapted for receiving optical fiber cable.

### CROSS-REFERENCE TO RELATED APPLICATIONS

This application is a national stage of PCT Application No. PCT/DK2023/050037, having a filing date of Mar. 7, 2023, which is based on DK Application No. PA202270089, having a filing date of Mar. 8, 2022, the entire contents both of which are hereby incorporated by reference.

### FIELD OF TECHNOLOGY

The following relates to a multiduct or flatliner assembly for guiding and protecting optical fiber cables in which the multiduct or flatliner assembly is adapted to have increased tensile strength by incorporating a tensile strength unit. The tensile strength unit enables the entire multiduct or flatliner assembly to be pulled through channels below infrastructure with an increased pull force without breaking, i.e., the multiduct or flatliner assembly has a higher pull force tolerance.

### BACKGROUND

The ever-increasing demand for higher internet bandwidth means that thousands of kilometres of multiduct assemblies for guiding and protecting optical fiber cables are being laid into the ground along infrastructure such as roads and buildings.

In many cases it is desirable to just dig a channel below this infrastructure and then pull the multiduct or flatliner assembly through it. Activity on a road for instance would thereby be disrupted to a much lesser degree, compared to shutting down the road entirely to facilitate a dig. In the latter example, vehicles would require redirection, and the road must be repaired afterwards. This increases both time costs and operation costs.

Thus, there is a need for a multiduct or flatliner assembly with increased tensile strength enabling pulling with a higher force.

### SUMMARY

An aspect relates to a multiduct or flatliner assembly for guiding and protecting optical fiber cables or optical waveguides, wherein the multiduct or flatliner assembly have increased tensile strength.

An aspect of embodiments of the invention is achieved by a multiduct or flatliner assembly for guiding and protecting optical fiber cables or optical waveguides. The multiduct or flatliner assembly comprises an outer sheath supporting a plurality of first longitudinal guides being in parallel relationship with the outer sheath and
at least one tensile strength unit extending inside the outer sheath, and/or
at least one longitudinal fiber rod extending inside the outer sheath, and/or
at least one metal rod extending inside the outer sheath, and/or
aramid fibers extending inside the outer sheath, and/or
fiberglass extending inside the outer sheath.

The plurality of first longitudinal guides is adapted for receiving optical fiber cable.

The at least one longitudinal fiber rod extend along the outer sheath and increases the tensile strength of the multiduct or flatliner assembly as a function of diameter of the fiber rod and a small increase in diameter of the fiber rod will significantly increase the tensile strength. The at least one longitudinal fiber rod will move within the multiduct or flatliner assembly as a function of temperature changes since the friction with the other components is not great enough to prevent the at least one longitudinal fiber rod from moving.

The at least one longitudinal metal rod extend along the outer sheath and increases the tensile strength of the multiduct or flatliner assembly as a function of diameter of the metal rod and a small increase in diameter of the metal rod will significantly increase the tensile strength. The at least one longitudinal metal rod will move within the multiduct or flatliner assembly as a function of temperature changes since the friction with the other components is not great enough to prevent the at least one longitudinal metal rod from moving.

The aramid fibers extend along the outer sheath and increases the tensile strength of the multiduct or flatliner assembly as a function of the combined diameter of the aramid fibers. The aramid fibers may extend loosely inside the outer sheet. The aramid fibers will significantly increase the tensile strength. The aramid fibers will move within the multiduct or flatliner assembly move as a function of temperature changes since the friction with the other components is not great enough to prevent the aramid fibers from moving.

The fiberglass extends along the outer sheath and increases the tensile strength of the multiduct or flatliner assembly as a function of the combined diameter of the fiberglass. The fiberglass may extend loosely inside the outer sheet. The fiberglass will significantly increase the tensile strength. The fiberglass will move within the multiduct or flatliner assembly move as a function of temperature changes since the friction with the other components is not great enough to prevent the fiberglass from moving.

In an aspect, the at least one tensile strength unit may comprise
a second longitudinal guide adapted for receiving optical fiber cable,
at least one longitudinal fiber rod external to the second longitudinal guide or at least one metal rod external to the second longitudinal guide, or loose aramid fibers external to the second longitudinal guide, or loose glass fibers external to the second longitudinal guide, and
an inner sheath supporting the second longitudinal guide and the at least one longitudinal fiber rod or the at least one metal rod or the loose glass fibers or the loose aramid fibers.

The longitudinal fiber rod increases the tensile strength of the multiduct or flatliner assembly as a function of diameter of the fiber rod and a small increase in diameter of the fiber rod will significantly increase the tensile strength.

For example, in the case where the sum of first and second longitudinal guides are 12 and the longitudinal guides have an outer diameter of 10 mm and an inner diameter of 6 mm then the maximum pull force will be roughly 12×400N=4800 N. The addition of a fiber rod being a fiberglass rod having a diameter of 2 mm will increase the maximum pull force by 3000 N which is an increase of 62.5% compared to an multiduct or flatliner assembly with no tensile strength unit. Thus, the multiduct or flatliner assembly being reinforced with a tensile strength unit can be pulled over longer distances.

The at least one tensile strength unit establishes an interference fitting between the second longitudinal guide, at least one longitudinal fiber rod or the at least one metal rod or the loose fiberglass or the fiberglass, and the inner sheath meaning that the at least one tensile strength unit becomes a single unit. In addition, an interference fitting is established between the at least one tensile strength unit, the first longitudinal guides, and the outer sheath. Thereby, the at least one longitudinal fiber rod or the at least one metal rod or the loose fiberglass or the fiberglass is prevented from moving due to changes in temperature.

The outer sheath and the inner sheath may be made using the same materials and using similar methods such as extrusion.

The first and second longitudinal guides may be identical or similar guides, where the only difference is whether they form part of the tensile strength unit or not.

The first and second longitudinal guides may be guide tubes having a substantially tubular cross-section.

The first longitudinal guides and the second longitudinal guide may be packed to form an overall hexagonal packing in a cross-section perpendicular to the longitudinal direction of the multiduct assembly, since a hexagonal packing has the highest packing density.

Thus, multiduct assembly will compared to the flatliner assembly have less perturbation of the overall structure due to overall hexagonal packing in a cross-section perpendicular to the longitudinal direction of the multiduct assembly.

However, there are spaces between the longitudinal guides and the least one longitudinal fiber rod can be fitted into the space between the longitudinal guides with little to no perturbation of the overall hexagonal structure.

The at least one tensile strength unit could have two or more longitudinal guides. This can in some cases however make it more difficult to keep an overall hexagonal structure. Furthermore, the purpose of the second longitudinal guides is to keep the longitudinal fiber rod in place relative to the other components.

The multiduct or flatliner assembly may comprise two, three, five or more tensile strength units.

The at least one tensile strength unit may comprise two, three, five or more longitudinal fiber rods.

The longitudinal fiber rod may comprise a diameter of 0.5 mm or 0.8 mm or 1.5 mm or 2.0 mm or 2.5 mm or larger depending on the required tensile strength.

In the case wherein the longitudinal fiber rod is a glass fiber rod with the diameters mentioned above, the maximum pull force will increase by 200 N (for 0.5 mm) or 500 N (for 0.8 mm) or 1500 N (for 1.5 mm) or 3000 (for 2.0 mm) or 4500 N (for 2.5 mm).

The metal rod may be iron rod or a steel rod.

The longitudinal metal rod may comprise a diameter of 0.5 mm or 0.8 mm or 1.5 mm or 2.0 mm or 2.5 mm or larger depending on the required tensile strength.

The loose aramid fibers will be kept in place by the inner sheath such that the aramid fibers will not move as function of temperature due to a higher friction compared to an embodiment without the inner sheath.

The loose fiberglass will be kept in place by the inner sheath such that the aramid fibers will not move as function of temperature due to a higher friction compared to an embodiment without the inner sheath.

In an aspect, the outer sheath may originate from an extrusion process establishing an interference fitting between the outer sheath and the plurality of first longitudinal guides and the at least one tensile strength unit. Thereby, the multiduct or flatliner assembly becomes more stable as drift between components is prevented.

In an aspect, the inner sheath may originate from an extrusion process establishing an interference fitting between the inner sheath and the second longitudinal guide and the at least one longitudinal fiber rod. Thereby, the at least one tensile strength unit becomes more stable as drift between components is prevented.

The inner sheath may comprise a thickness between 0.5-1.1 mm or 0.7-0.9 mm. The inner sheath may be thinner than the outer sheath since the inner sheath is impart protected from impact by the outer sheath.

In an aspect the plurality of first longitudinal guides may comprise at least 2-5, 6-9, 10-16, 17-25 microducts.

The microducts being defined by an inner diameter and outer diameter, wherein the inner diameter defines a volume for pulling optical fiber cables or optical waveguides.

The microducts may have longitudinal grooves along an inner side.

The plurality of first longitudinal guides may be arranged in a hexagonal packing.

The second longitudinal guide may also be a microduct having one, more or all the features discussed for the first longitudinal guides in the application.

In an aspect the microducts may comprise an outer diameter between 5-20 mm.

The microducts may comprise an inner diameter between 2-16 mm.

The microduct outer/inner diameter may be 4 mm/2 mm or 5 mm/3.5 mm or 8 mm/4 mm or 10 mm/6 mm or 10 mm/8 mm or 12 mm/8 mm or 12 mm/10 mm or 14 mm/10 mm or 14 mm/12 mm or 16 mm/14 mm or 20 mm/15 mm or 20 mm/16 mm.

In the list above the first value is the outer diameter and the second value is the inner diameter.

In an aspect the outer sheath comprises a thickness between 0.5-1.3 mm or 0.7-1.1 mm.

The thickness enables the outer sheath to withstand impacts and wear during the pulling of the multiduct or flatliner assembly.

In an aspect the plurality of first longitudinal guides may comprise a central-positioned longitudinal guide with an outer diameter of at least 20 mm and wherein the central-positioned longitudinal guide being surrounded by the other first longitudinal guides and the at least one tensile strength unit.

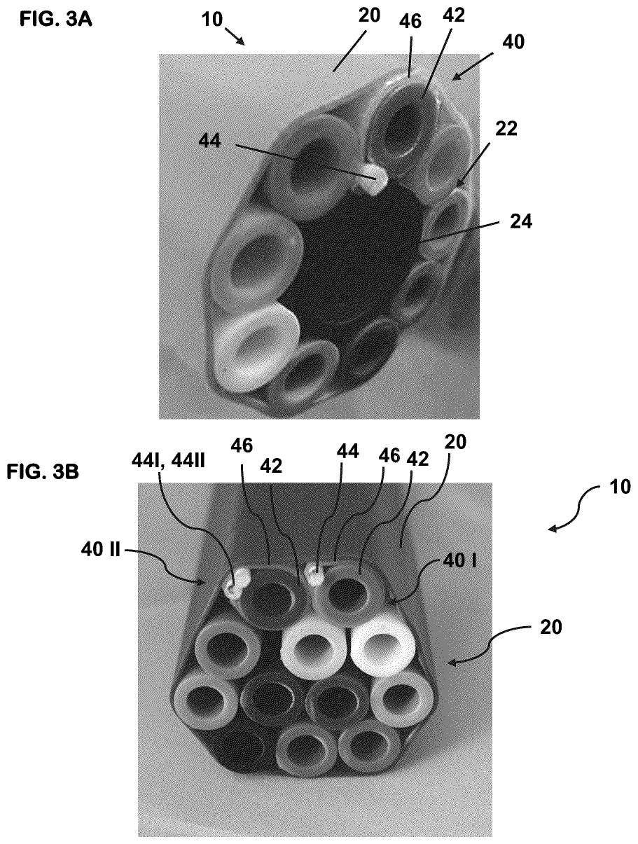

Thereby, a different configuration than the hexagonal packing is possible while achieving an increased tensile strength. An embodiment is shown in FIG. 3A.

The other first longitudinal guides have a smaller outer diameter than the central-positioned longitudinal guide.

In an embodiment, the at least one tensile strength unit has a central-positioned and the second longitudinal guide comprise an outer diameter of at least 20 mm.

In an aspect at least one of the at least one longitudinal fiber rod comprises a fiber reinforced polymer such as fiberglass or aramid fiber or Kevlar yarn, nylon yarn.

Thereby, the at least one longitudinal fiber rod has a high tensile strength.

An aspect of embodiments of the invention is achieved by a method of producing a multiduct or flatliner assembly with a tensile strength unit. In embodiments, the method comprises
a step of providing a second longitudinal guide adapted for receiving optical fiber cable, and at least one longitudinal fiber rod, or at least one metal rod or loose aramid fibers, or loose fiberglass; and
a step of orienting the at least one longitudinal fiber rod or the at least one metal rod or the loose aramid fibers, or the loose fiberglass external to and in parallel with the second longitudinal guide;
a step of extruding an inner sheath around the second longitudinal guide and the at least one longitudinal fiber rod or the at least one metal rod or the loose aramid fibers, or the loose fiberglass; thereby forming a tensile strength unit;
a step of providing a plurality of first longitudinal guides;
a step of orienting the tensile strength unit and the plurality of first longitudinal guides in parallel; and
a step of extruding an outer sheath around the tensile strength unit and the plurality of first longitudinal guides.

In embodiments, the method enables production of a multiduct or flatliner assembly along a single process line. In the case where more than a single tensile strength unit is desired, the first three steps are simply repeated.

An aspect of embodiments of the invention is achieved by use of the multiduct or flatliner assembly according to embodiments of the invention to pull through channels below infrastructure.

The infrastructure may be a road or a building.

An aspect of embodiments of the invention is achieved by use of a tensile strength unit for increasing tensile of a multiduct or flatliner assembly comprising outer sheath supporting a plurality of first longitudinal guides being in parallel relationship with the outer sheath. The tensile strength unit comprises
a second longitudinal guide adapted for receiving optical fiber cable,
at least one longitudinal fiber rod or at least one metal rod or loose aramid fibers or loose fiberglass extending along and external to the second longitudinal guide, and
an inner sheath supporting the second longitudinal guide and the at least one longitudinal fiber rod or the at least one metal rod or the loose aramid fibers or the loose fiberglass.

As previously described the use of the tensile strength unit with a longitudinal fiber rod can in some cases increase the maximum pull force with 62.5%.

The inner sheath is extruded onto the second longitudinal guide and the at least one longitudinal fiber rod or at least one metal rod or loose aramid fibers or loose fiberglass to achieve an interference fitting.

### BRIEF DESCRIPTION

Some of the embodiments will be described in detail, with references to the following Figures, wherein like designations denote like members, wherein:

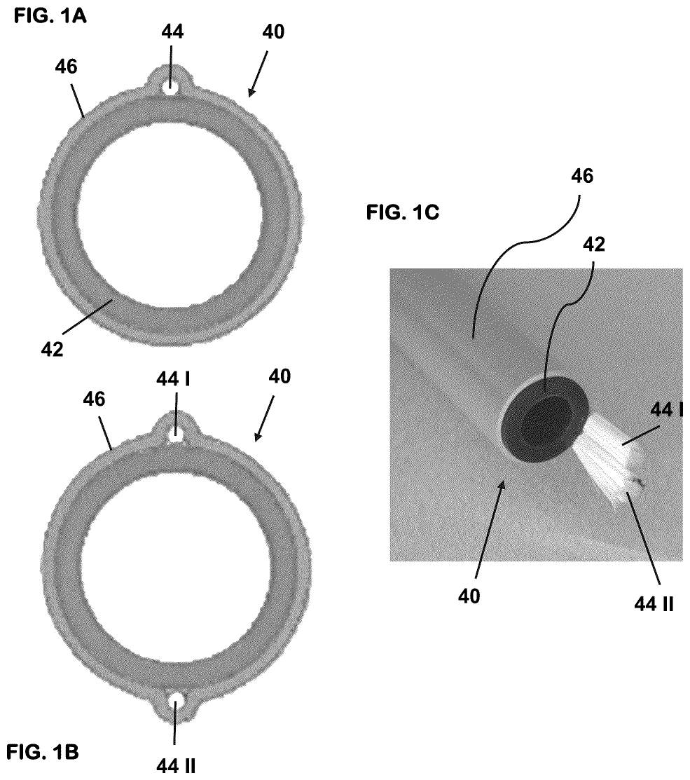

FIG. 1A illustrates a first exemplary tensile strength unit;

FIG. 1B illustrates a second exemplary tensile strength unit;

FIG. 1C illustrates a third exemplary tensile strength unit;

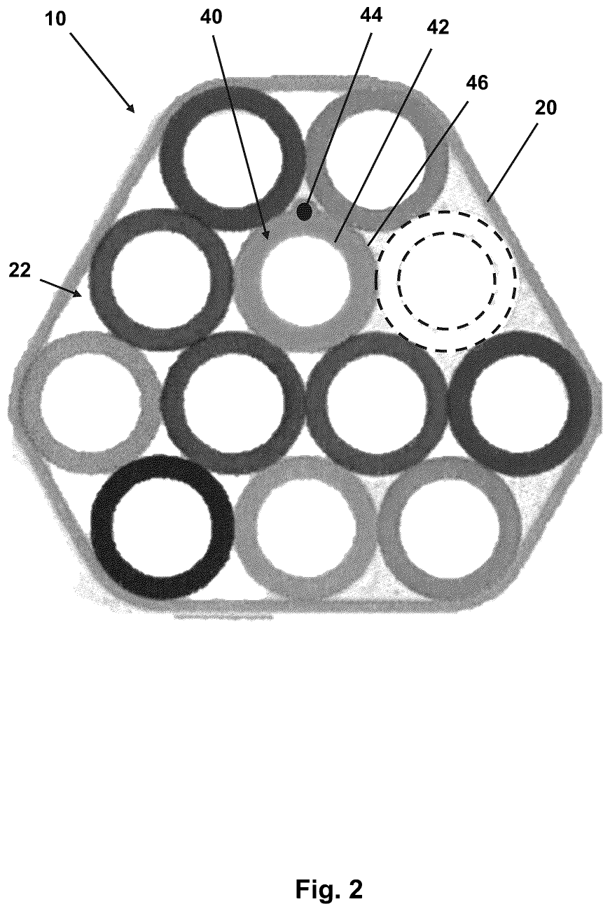

FIG. 2 illustrates an embodiment of a multiduct assembly;

FIG. 3A illustrates an embodiment of a multiduct assembly;

FIG. 3B illustrates a further embodiment of a multiduct assembly; and

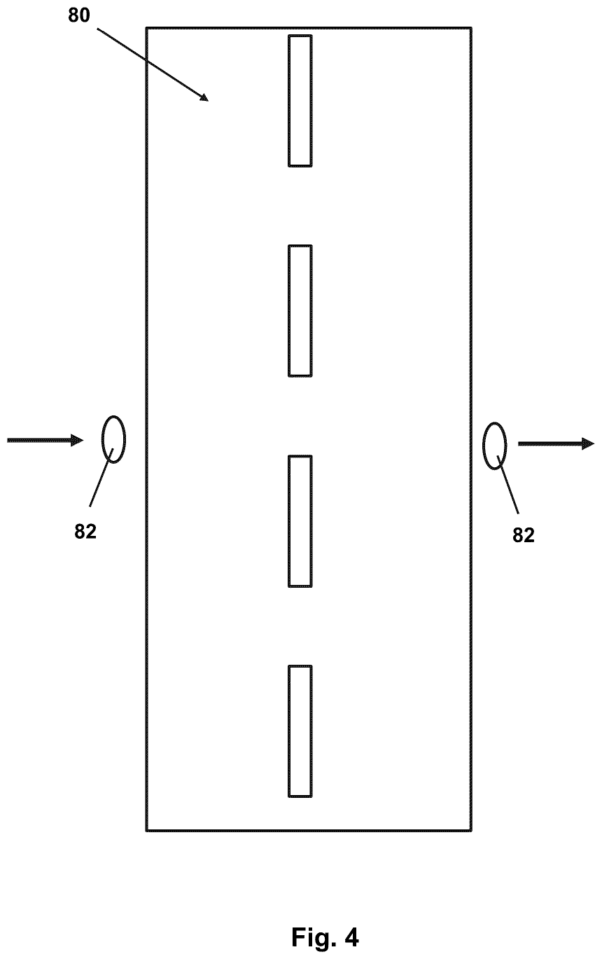

FIG. 4 illustrates infrastructure and a channel.

| Item | Reference |
|---|---|
| Multiduct assembly | 10 |
| Outer sheath | 20 |
| First longitudinal guides | 22 |
| Central-positioned longitudinal guide | 24 |
| Tensile strength unit | 40 |
| Second longitudinal guide | 42 |
| Longitudinal fiber rod | 44 |
| Inner sheath | 46 |
| Infrastructure | 80 |
| Channels | 82 |

### DETAILED DESCRIPTION

FIGS. 1A-1C illustrate three different tensile strength units 40. The three different tensile strength units 40 are shown in 1A, 1B and 1C, respectively.

Each of the shown tensile strength units 40 comprise a second longitudinal guide 42 adapted for receiving optical fiber cable, and at least one longitudinal fiber rod 44 external to the second longitudinal guide 42, and an inner sheath 46 supporting the second longitudinal guide 42 and the at least one longitudinal fiber rod 44.

The tensile strength units 40 shown in 1B and 1C have two longitudinal fiber rods 44I, 44II and the difference between the two embodiments is the positioning of the fiber rods 44I, 44II. The fiber rods 44I, 44II in 1B are positioned on opposite sides of the second longitudinal guide while the fiber rods 44I, 44II in 1C are positioned next to each other. The tensile strength in 1B and 1C will be the same if identical fiber rods 44I, 44II are used.

The two fiber rods 44I, 44II may be placed anywhere between the two extremes 1B and 1C.

FIG. 2 illustrates an embodiment of a multiduct assembly 10. The multiduct assembly 10 comprises an outer sheath 20 supporting a plurality of first longitudinal guides 22 being in parallel relationship with the outer sheath 20 and at a tensile strength unit 40.

The plurality of first longitudinal guides 22 are adapted for receiving optical fiber cables. The first longitudinal guides 22 are in a hexagonal configuration.

The tensile strength unit 40 comprises a second longitudinal guide 42 adapted for receiving optical fiber cable and a longitudinal fiber rod 44 external to the second longitudinal guide 42 and an inner sheath 46 supporting the second longitudinal guide 42 and the longitudinal fiber rod 44.

The tensile strength unit 40 is similar to the tensile strength unit 40 shown in FIG. 1A, however one could substitute the shown tensile strength unit 40 for the tensile strength unit 40 in either of FIG. 1B or 1C.

The first longitudinal guides 22 are shown having different levels of grey scale this is due to the first longitudinal guides 22 typically having different colors. This is however not relevant for embodiments of the present invention. This is also the reason why the white first longitudinal guide 22 has been drawn using stippled lines.

FIGS. 3A and 3B illustrate two embodiments of a multiduct assembly 10 shown in 3A and 3B, respectively.

The multiduct assembly 10 in FIG. 3A comprises an outer sheath 20 supporting a plurality of first longitudinal guides 22 being in parallel relationship with the outer sheath 20 and at a tensile strength unit 40.

The plurality of first longitudinal guides 22 are adapted for receiving optical fiber cables. The plurality of first longitudinal guides 22 comprises a central-positioned longitudinal guide 24 with an outer diameter being larger than the other first longitudinal guides 22 and wherein the central-positioned longitudinal guide 24 being surrounded by the other first longitudinal guides and the at least one tensile strength unit 40.

The tensile strength unit 40 comprises a second longitudinal guide 42 adapted for receiving optical fiber cable and a longitudinal fiber rod 44 external to the second longitudinal guide 42 and an inner sheath 46 supporting the second longitudinal guide 42 and the longitudinal fiber rod 44.

The tensile strength unit 40 is similar to the tensile strength unit 40 shown in FIG. 1A, however one could substitute the shown tensile strength unit 40 for the tensile strength unit 40 in either of FIG. 1B or 1C.

The multiduct assembly 10 in FIG. 3B comprises an outer sheath 20 supporting a plurality of first longitudinal guides 22 being in parallel relationship with the outer sheath 20 and at two tensile strength units 401, 4011.

The plurality of first longitudinal guides 22 are adapted for receiving optical fiber cables. The first longitudinal guides 22 are in a hexagonal configuration.

The tensile strength unit 401 comprises a second longitudinal guide 42 adapted for receiving optical fiber cable and a longitudinal fiber rod 44 external to the second longitudinal guide 42 and an inner sheath 46 supporting the second longitudinal guide 42 and the longitudinal fiber rod 44.

The tensile strength unit 401 is similar to the tensile strength unit 40 shown in FIG. 1A, however one could substitute the shown tensile strength unit 401 for the tensile strength unit 40 in either of FIG. 1B or 1C.

The tensile strength unit 4011 comprises a second longitudinal guide 42 adapted for receiving optical fiber cable and two longitudinal fiber rods 44I, 44II external to the second longitudinal guide 42 and an inner sheath 46 supporting the second longitudinal guide 42 and the longitudinal fiber rod 44.

The tensile strength unit 401 is similar to the tensile strength unit 40 shown in FIG. 1A, however one could substitute the shown tensile strength unit 401 for the tensile strength unit 40 in either of FIG. 1B or 1C.

FIG. 4 illustrates infrastructure 80 and a channel 82. The multiduct assembly 10 according to embodiments of the invention can be pulled with a larger force and thus can be pulled over larger distances without damaging the infrastructure 80.

In the example the infrastructure 80 is a road.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A multiduct or flatliner assembly for guiding and protecting optical fiber cables or optical waveguides, the multiduct or flatliner assembly comprising:
an outer sheath supporting a plurality of first longitudinal guides being in parallel relationship with the outer sheath and
at least one tensile strength unit extending inside the outer sheath, and/or
at least one longitudinal fiber rod extending inside the outer sheath, and/or
at least one metal rod extending inside the outer sheath, and/or
aramid fibers extending inside the outer sheath, and/or
fiberglass extending inside the outer sheath, and
the plurality of first longitudinal guides configured for receiving optical fiber cable.

2. The multiduct or flatliner assembly according to claim 1, wherein the at least one tensile strength unit comprises:
a second longitudinal guide configured for receiving optical fiber cable,
at least one longitudinal fiber rod external to the second longitudinal guide, or at least one metal rod external to the second longitudinal guide, or loose aramid fibers external to the second longitudinal guide, or loose fiberglass external to the second longitudinal guide and
an inner sheath supporting the second longitudinal guide and the at least one longitudinal fiber rod or the at least one metal rod or the loose fiberglass or the fiberglass.

3. The multiduct or flatliner assembly according to claim 2, wherein the outer sheath and/or the inner sheath originating from an extrusion process an interference fitting between
the outer sheath and the plurality of first longitudinal guides and the at least one tensile strength unit; and/or
the inner sheath and the second longitudinal guide and the at least one longitudinal fiber rod.

4. The multiduct or flatliner assembly according to claim 1, wherein the plurality of first longitudinal guides comprises at least 2-5, 6-9, 11-16, or 17-25 microducts.

5. The multiduct or flatliner assembly according to claim 4, wherein the microducts comprise an outer diameter between 7-20 mm.

6. The multiduct or flatliner assembly according to claim 1, wherein the outer sheath comprises a thickness between 0.5-1.3 mm or 0.7-1.1 mm.

7. The multiduct or flatliner assembly according to claim 1, wherein the plurality of first longitudinal guides comprises a central-positioned longitudinal guide with an outer diameter of at least 20 mm and wherein the central-positioned longitudinal guide being surrounded by the other first longitudinal guides and the at least one tensile strength unit.

8. The multiduct or flatliner assembly according to claim 1, wherein at least one of the at least one longitudinal fiber rod comprises a fiber reinforced polymer such as fiberglass or aramid fiber or Kevlar yarn, nylon yarn.

9. A method of producing a multiduct or flatliner assembly with a tensile strength unit, the method comprising:
providing a second longitudinal guide configured for receiving optical fiber cable, and —at least one longitudinal fiber rod, or at least one metal rod or loose aramid fibers, or loose fiberglass; and
orienting the at least one longitudinal fiber rod or the at least one metal rod or the loose aramid fibers, or the loose fiberglass external to and in parallel with the second longitudinal guide;
extruding an inner sheath around the second longitudinal guide and the at least one longitudinal fiber rod or the at least one metal rod or the loose aramid fibers, or the loose fiberglass; thereby forming a tensile strength unit;
providing a plurality of first longitudinal guides;
orienting the tensile strength unit and the plurality of first longitudinal guides in parallel; and
extruding an outer sheath around the tensile strength unit and the plurality of first longitudinal guides.

10. A method comprising: utilizing the multiduct or flatliner assembly according to claim 1 to pull through channels below infrastructure.

11. A method comprising: utilizing a tensile strength unit for increasing tensile of a multiduct or flatliner assembly comprising outer sheath supporting a plurality of first longitudinal guides being in parallel relationship with the outer sheath, wherein the tensile strength unit comprises:
a second longitudinal guide configured for receiving optical fiber cable,
at least one longitudinal fiber rod or at least one metal rod or loose aramid fibers or loose fiberglass extending along and external to the second longitudinal guide, and
an inner sheath supporting the second longitudinal guide and the at least one longitudinal fiber rod or the at least one metal rod or the loose aramid fibers or the loose fiberglass.
